(19) United States
(12) Patent Application Publication
(10) Pub. No.: US 2015/0159797 A1
(43) Pub. Date: Jun. 11, 2015

(54) System and Method to Control Electrical Power Input to Direct Electric Heat Pipeline

(71) Applicant: EXXONMOBIL UPSTREAM RESEARCH COMPANY, Houston, TX (US)

(72) Inventor: John Leslie Baker, Houston, TX (US)

(21) Appl. No.: 14/395,004

(22) PCT Filed: Apr. 30, 2013
(86) PCT No.: PCT/US2013/038888

§ 371 Date: Oct. 16, 2014

Related U.S. Application Data
(60) Provisional application No. 61/660,495, filed on Jun. 15, 2012.

(51) Int. Cl. F16L 53/00

(52) U.S. Cl. CPC F16L 53/004; F16L 53/005

(57) ABSTRACT

A system and method to control the electrical power input to direct electrically heated subsea pipelines. The system comprises a plurality of variable voltage generators and a plurality of step-up transformers. Each step-up transformer is electrically connected to the output of an associated generator. The system further comprises a plurality of variable step-down transformers. Each step-down transformer is electrically connected the output of the step-up transformers and to an associated pipeline segment.

### CROSS-REFERENCE TO RELATED APPLICATION

This application claims the priority benefit of U.S. Provisional Patent Application 61/660,495 filed 15 Jun. 2012 entitled System and Method To Control Electrical Power Input to Direct Electric Heat Pipeline, the entirety of which is incorporated by reference herein.

### FIELD OF INVENTION

This invention generally relates to the field of subsea pipeline heating and, more particularly, to a system and method to control the electrical heating of subsea pipeline segments.

### BACKGROUND

This section is intended to introduce various aspects of the art, which may be associated with exemplary embodiments of the present invention. This discussion is believed to assist in providing a framework to facilitate a better understanding of particular aspects of the present invention. Accordingly, it should be understood that this section should be read in this light, and not necessarily as admissions of prior art.

As offshore hydrocarbon recovery systems have continued to develop, the environments in which such systems may be utilized have also evolved. Increasingly, hydrocarbon recovery systems are being installed in deep water and/or arctic environments. As a result of these extremely cold conditions, the ability of the hydrocarbon fluids and any water present to adequately flow through the pipeline is substantially affected. For example, gas hydrates may form within the pipeline as the gas and water present within the pipeline are subjected to high pressure and low temperatures.

FIG. 1 depicts the environment in which some offshore recovery systems may operate. Vessel 101 floats in the water 103 and is held in place by the combination of mooring line 105 and anchor 107. Mooring line 105 is fixed to vessel 101 and anchor 107, which is held in place by being driven into the seabed 109. Hydrocarbons are recovered from wellhead 111 and delivered to vessel 101 via pipeline 113. In the depicted example, pipeline 113 consists of riser section 115 and seafloor section 117. As appreciated by those skilled in the art, seafloor section 117 may be located thousands of feet below waterline 103. Because of the high pressure and low temperature, there is an increased likelihood that hydrates will form in seafloor section 117.

Direct electric heating of subsea pipeline systems is one technique used to eliminate hydrate formation in seafloor sections subsea pipelines. Heating through electrical methodologies is well known by those skilled in the art. For example, the pipe-in-pipe method is one known electrical heating technique. One example of the pipe-in-pipe method is disclosed in U.S. Pat. No. 6,142,707 to Bass et al.

Power supply systems for direct electric heating for subsea pipelines can be complex and inefficient. One known technique is described in U.S. Pat. No. 6,707,012 to Stone, Jr. The Stone system utilizes a variable frequency drive to deliver variable voltage at a fixed frequency to the subsea via a subsea power cable. A distributed control system varies the drives output voltage as required to maintain the pipeline's temperature. Unfortunately, the Stone system is most suitable for short pipeline segments as the reactive charging current requirement associated with a long power cable may be greater than the variable frequency drive's capability. Longer pipeline segments using a variable frequency drive's single phase voltage supply would be limited in length due to power cable voltage drop and cable size limitations. The Stone design requires a utility, or dedicated source of fixed voltage three phase power, in conjunction with the variable frequency drive. However, in remote environments where a utility is unavailable, such as, but not limited to, the arctic, the cost and complexity involved in installing the Stone system would prove impractical.

Thus, there is a need for improvement in this field.

### SUMMARY OF THE INVENTION

The present invention provides a system and method to control electrical power input to direct electric heated pipelines.

One embodiment of the present disclosure is a system for heating a subsea pipeline composed of a plurality of pipeline segments comprising: a plurality of variable voltage generators; a plurality of step-up transformers, each step-up transformer electrically connected to the output of an associated generator; and a plurality of variable step-down transformers, each step-down transformer electrically connected the output of the step-up transformers, each step-down transformer is electrically connected to an associated pipeline segment.

The foregoing has broadly outlined the features of one embodiment of the present disclosure in order that the detailed description that follows may be better understood. Additional features and embodiments will also be described herein.

### BRIEF DESCRIPTION OF THE DRAWINGS

The present invention and its advantages will be better understood by referring to the following detailed description and the attached drawings.

FIG. 1 depicts an example environment in a subsea pipeline heating system may be applied.

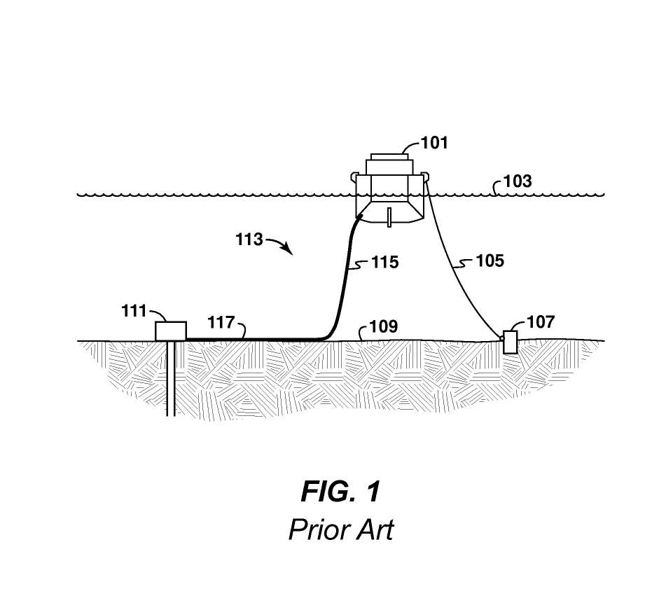

FIG. 2 is a block diagram of a subsea pipeline heating system according to one embodiment of the present disclosure.

FIG. 3 is a partial schematic view of the subsea components of a subsea pipeline heating system according to one embodiment of the present disclosure.

FIG. 4 is a flowchart showing the basic steps of controlling a power input to a pipeline segment according to one embodiment of the present disclosure.

It should be noted that the figures are merely examples of several embodiments of the present invention and no limitations on the scope of the present invention are intended thereby. Further, the figures are generally not drawn to scale, but are drafted for purposes of convenience and clarity in illustrating various aspects of certain embodiments of the invention.

### DESCRIPTION OF THE SELECTED EMBODIMENTS

For the purpose of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates. One embodiment of the invention is shown in great detail, although it will be apparent to those skilled in the relevant art that some features that are not relevant to the present invention may not be shown for the sake of clarity.

Persons skilled in the technical field will readily recognize that in practical applications of the disclosed methodology, some aspects must be performed on a computer, typically a suitably programmed digital computer. Further, some portions of the detailed descriptions which follow are presented in terms of procedures, steps, logic blocks, processing and other symbolic representations of operations on data bits within a computer memory. These descriptions and representations are the means used by those skilled in the data processing arts to most effectively convey the substance of their work to others skilled in the art. In the present application, a procedure, step, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present application, discussions utilizing the terms such as “providing,” “receiving,” “waiting,” “determining,” “adjusting,” and “maintaining” or the like, may refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

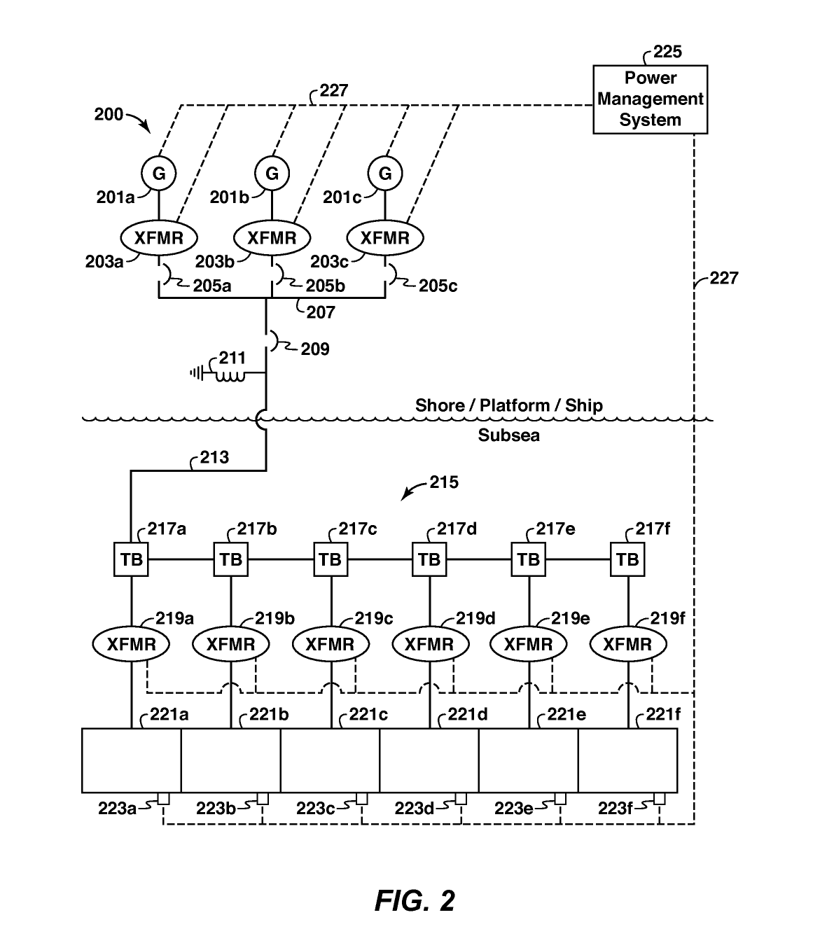

A subsea pipeline heating system 200 according to one embodiment of the present disclosure is depicted in FIG. 2. In the depicted embodiment, system 200 contains multiple variable generators 201a-201c constructed and arranged to generate electrical power. The output of each generator 201a-201c is electrically connected to an associated variable step-up transformer 203a-203c. The output of each step-up transformer 203a-203c is electrically connected to a bus 207 and an associated circuit breaker 205a-205c is provided in-line.

A fixed reactor 211 and power cable 213 are electrically connected in parallel to bus 207 via circuit breaker 209. Fixed reactor 211 is sized to compensate for the power cable 213 charging current, thereby minimizing its impact on generators 201a-201c.

Power cable 213 electrically connects the electricity generated by generators 201a-201c to a variety of subsea components, generally identified by reference numeral 215. More specifically, the high voltage outputs from step-up transformers 203a-203c are transmitted by power cable 213 to a plurality of tap boxes 217a-217f. Each tap box 217a-217f is electrically connected to an associated step-down transformer 219a-219f. As appreciated by those skilled in the art, subsea tap boxes 217a-217f provide a means of connection for the power cable 213 and the individual cables feeding the primary winding of each of the subsea step-down transformers 219a-219f. The secondary from each step-down transformer 219a-219f is electrically connected to a pipeline segment 221a-221f.

In order to monitor the temperature of pipeline segments 221a-221f, temperature sensors 223a-223f are provided for each pipeline segment in the depicted embodiment. The outputs of the temperature sensors 223a-223f are communicatively connected to a power management system 225 through a communication line 227. Communication line 227 may be a wired or wireless connection, or a combination of the two. In the depicted embodiment, power management system 225 is also in communicative and operative connection with generators 201a-201c, step-up transformers 203a-203c, and step-down transformers 219a-219f. In other embodiments, power management system 225 is in communicative and operative connection with more or fewer components of system 200, including components identified generally by reference numeral 215.

In one embodiment of the present disclosure, the generators operate in an N+1 configuration when the system is warming up and has its maximum power requirement. In such an embodiment, the two generators that are connected share the load equally. When the total power requirement is less than the output of one generator, the system will then operate in an N+2 configuration. In both schemes, at least one redundant generator is provided. In some embodiments, the heating system includes only two generators. In other embodiments, multiple generators are electrically connected to the subsea pipeline heating system.

In one embodiment, the power management system 225 is constructed and arranged to control the output voltage of generators 201a-201c and the tap changer of step-up transformers 203a-203c in order to coarsely set the power system voltage supplied to the primaries of the subsea step-down transformers 219a-219f. In one embodiment, the variation in generator output provides a coarse level of control for the pipeline temperature.

In some embodiments, a secondary voltage tap controller is provided on each subsea step-down transformer 219a-219f. In some embodiments, each of the subsea pipeline segments 221a-221f may be finely tuned to a precise temperature by the power management system 225 via the secondary voltage tap controllers. In such embodiments, power management system 225 uses temperature feedback from temperature sensors 223a-223f for fine tuning temperature.

In one embodiment, generators 201a-201c are industrial gas turbine generators. In some embodiments, generators 201a-201c are specially designed, constructed and arranged to allow their output voltage to be controlled from 50% to 100%. In one embodiment, the generator output voltage is controlled based, at least in part, on the average temperature calculated from temperature sensors 223a-223f which monitor each of the pipeline segments 221a-221f. In some embodiments, more than one temperature sensor is provided for each pipeline segment. In other embodiments, the number of temperature systems is less than the number of pipeline segments. In other embodiments, sensors other than temperature-based sensors may be used to detect conditions within the pipeline segments. In such embodiments, the power management system is in communicative connection with such sensors in order to maintain pipeline temperature within a set range.

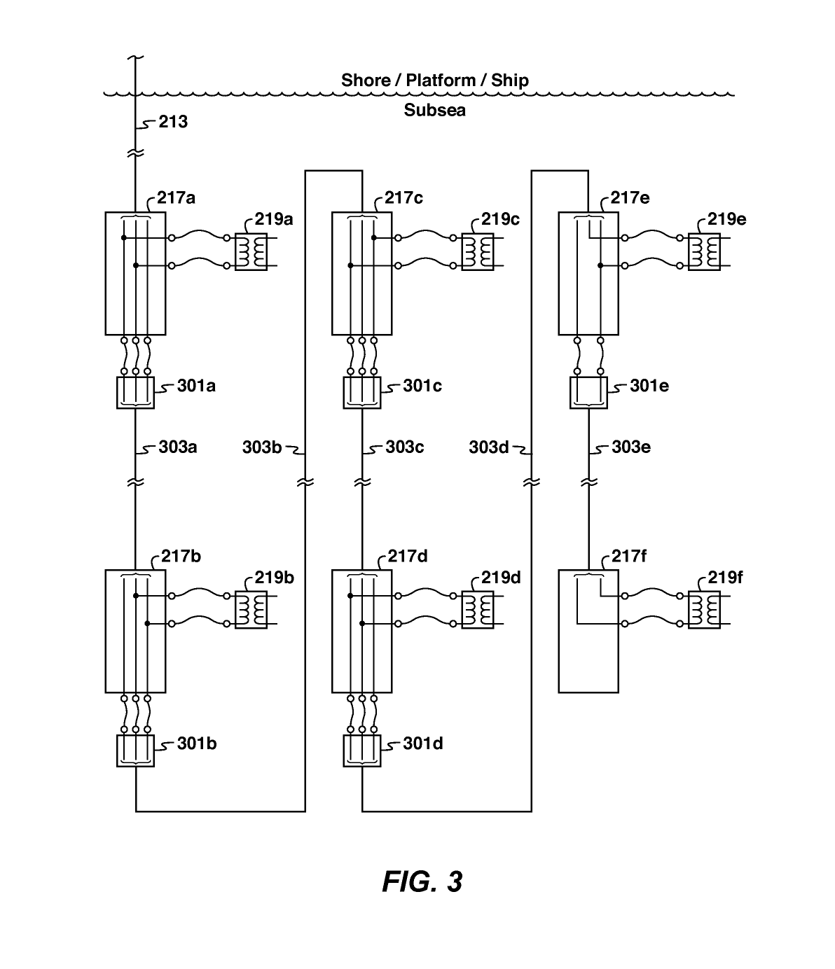

FIG. 3 depicts a partial schematic view of the subsea components of a subsea pipeline heating system according to one embodiment of the present disclosure. Components common between the embodiments provided in FIGS. 2 and 3 will share reference numerals. As illustrated, six subsea single phase transformers 219a-219f are fed by six subsea tap boxes 217a-217f. Though not depicted, subsea transformers 219a-219f have their secondary windings connected to direct electric heating pipeline segments. Tap boxes 217a-217f serve the function of splitting out the three phases from the power cable, two of which are provided to a transformer. In the depicted embodiment, power cable 213 provides energy from the onshore power generation system to the first tap box 217a. In one embodiment, phases A-B are provided to transformer 219a. All three phases are provided to an umbilical termination assembly (UTA) 301a. UTA 301a combines the three phases into a single power line jumper 303a which electrically connects UTA 301a to tap box 217b. At tap box 217b, phases B-C are provided to transformer 219b. In one embodiments, the connection of the split phases by tap boxes 217a-217f are sequential, i.e., AB, BC, CA.

In the depicted embodiment, tap box 217f receives only two cores. In the depicted embodiment, tap boxes 217a-217d are identical in the number of connections on the transformer side (2) and the number of connections of the UTA side (3). The only difference between tap boxes 217a-217d are the phase connections. Further in the depicted embodiment, tap box 217e contains two connections on both the transformer and UTA side whereas tap box 217f only has two connectors on the transformer side.

In other embodiments, all tap boxes receive all three cores and the associated transformer connects to the phases as dictated by system design. In some embodiments, all of the tap boxes in the system have two transformer connections and two UTA connections. In some embodiments, the tap boxes may include further connections for other system components not depicted. In some embodiments, the connections on the tap boxes are wet mate connections which allow for the tap boxes to be safely connected and disconnected subsea. In other embodiments, tap boxes are equipped with standard dry mate connections.

In one embodiment, generators 201a-201c have a rating of 38.6 MW at 0.8 p.f. and an output voltage of 11 kV at a frequency of 50 Hz. The output voltage has a range of 50-100%. In one embodiment, step-up transformers 203a-203c have a rating of 50 MVA with a voltage of 11/120 kV. The step-up transformers may have a tap range of +/−5% with the tap set at 2.5%. In one embodiment, bus 207 has a rating of 120 kV. In one embodiment, shunt reactor 211 has a total rating of 145 MVAr. In one embodiment, shunt reactor compensator is made up of three individual sections with ratings of 130 MVAr, 10 MVAr and 5 MVAr giving a total rating of 145 MVAr at 120 kV. In one embodiment, power cable 213 and power line jumpers 303a-303e have a voltage rating of 145 kV and a current rating of 790 A. In one embodiment, subsea step-down transformers 219a-219f are single phase transformers with a rating of 12 MVA and a secondary winding voltage rating of 5 kV. In one embodiment, step-up and step-down transformers have an adjustable tap control. In one embodiment, step-down transformer 219a has its secondary voltage setting at 4.7 kV, step-down transformer 219b has its secondary voltage setting at 4.57 kV, step-down transformer 219c has its secondary voltage setting at 4.5 kV, step-down transformer 219d has its secondary voltage setting at 4.43 kV, step-down transformer 219e has its secondary voltage setting at 4.36 kV, and step-down transformer 219a has its secondary voltage setting at 4.35 kV. In one embodiment, pipeline sections 221a-221f have an individual length of 33.3 km.

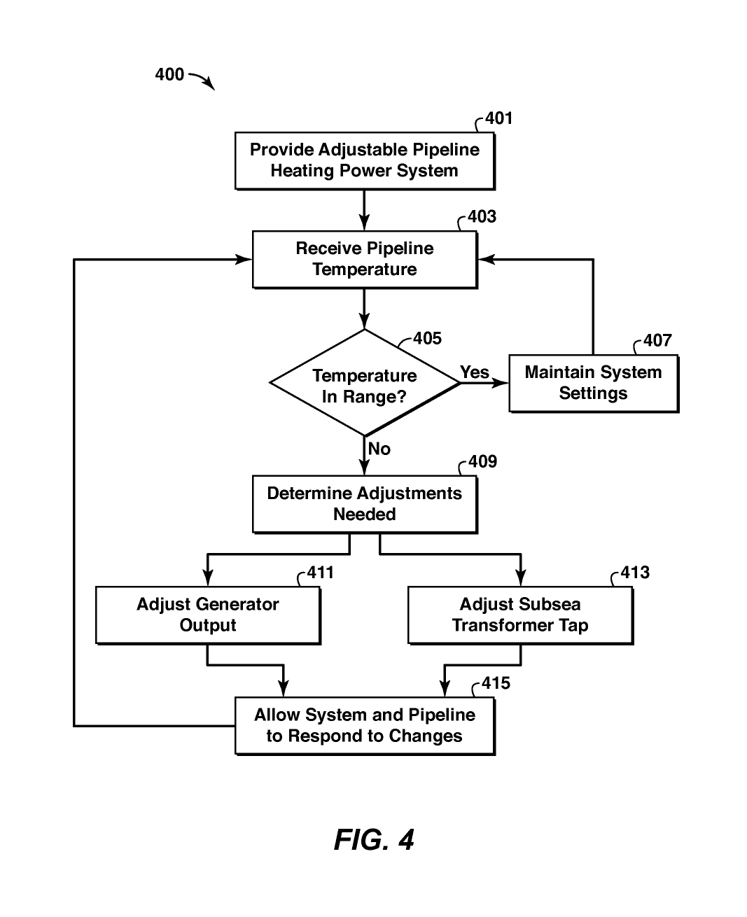

The flowchart of FIG. 4 will be referred to in describing one embodiment of the present disclosure for controlling a power input to a pipeline segment. The depicted process 400 begins by providing an adjustable pipeline heating power system (step 401), such as, but not limited to, system 200 depicted in FIG. 2 and described herein. The process continues by receiving a temperature associated with at least one pipeline segment (step 403). The power management system will then evaluate the at least one pipeline segment to determine whether the temperature of the segment is within an acceptable, predefined temperature range (step 405). If the temperature is within range, the current system settings are maintained (step 407) and the system awaits further temperature readings.

If the temperature is outside the acceptable range, the power management system will determine the adjustments to be made to the system components in order to return the pipeline temperature to an acceptable level (step 409). In order to perform coarse power control, the generator output voltage may be adjusted (step 411). If finer power control is warranted, the subsea transformer tap may be adjusted (step 413). In some embodiments, both the generator output voltage and subsea transformer tap may be adjusted. After the adjustments have been made, it will take some amount of time for the changes to trickle through the system resulting in a change in the pipeline temperature (step 415). Eventually, further temperature readings will be received and the process will repeat.

It is important to note that the steps depicted in FIG. 4 are provided for illustrative purposes only and a particular step may not be required to perform the inventive methodology. The claims, and only the claims, define the inventive system and methodology.

Embodiments of the present invention also relate to an apparatus for performing the operations herein. This apparatus may be specially constructed for the required purposes, or it may comprise a general-purpose computer selectively activated or reconfigured by a computer program stored in the computer. Such a computer program may be stored in a computer readable medium. A computer-readable medium includes any mechanism for storing or transmitting information in a form readable by a machine (e.g., a computer). For example, but not limited to, a computer-readable (e.g., machine-readable) medium includes a machine (e.g., a computer) readable storage medium (e.g., read only memory (“ROM”), random access memory (“RAM”), magnetic disk storage media, optical storage media, flash memory devices, etc.), and a machine (e.g., computer) readable transmission medium (electrical, optical, acoustical or other form of propagated signals (e.g., carrier waves, infrared signals, digital signals, etc.)).

Furthermore, as will be apparent to one of ordinary skill in the relevant art, the modules, features, attributes, methodologies, and other aspects of the invention can be implemented as software, hardware, firmware or any combination of the three. Of course, wherever a component of the present invention is implemented as software, the component can be implemented as a standalone program, as part of a larger program, as a plurality of separate programs, as a statically or dynamically linked library, as a kernel loadable module, as a device driver, and/or in every and any other way known now or in the future to those of skill in the art of computer programming. Additionally, the present invention is in no way limited to implementation in any specific operating system or environment.

The following lettered paragraphs represent non-exclusive ways of describing embodiments of the present disclosure.

A. A system for heating a subsea pipeline composed of a plurality of pipeline segments comprising: a plurality of variable voltage generators; a plurality of step-up transformers, each step-up transformer electrically connected to the output of an associated generator; and a plurality of variable step-down transformers, each step-down transformer electrically connected the output of the step-up transformers, each step-down transformer is electrically connected to an associated pipeline segment.

B. The system of paragraph A further comprising a plurality of temperature sensors, each temperature sensor associated with one of the pipeline segments, wherein the temperature sensors are constructed and arranged to output a temperature of the associated pipeline segment.

C. The system of any preceding paragraph further comprising a power management system communicatively and operatively connected to the plurality of generators and the plurality of step-down transformers.

D. The system of paragraph C wherein the power management system is communicatively connected the plurality of temperature sensors.

E. The system of any preceding paragraph further comprising a power cable electrically connecting the output of the step-up transformers to the input of the step-down transformers.

F. The system of paragraph E further comprising a fixed reactor electrically connected to the outputs of the step-up transformers in parallel to the power cable.

G. The system of paragraph E or F, wherein the power cable delivers three phase electric power.

H. The system of paragraph E or F or G further comprising a plurality of tap boxes electrically connected to the input of an associated step-down transformer, the tap boxes electrically connect the energy delivered by the power cable to the input of the associated step-down transformer.

I. The system of paragraph H, wherein at least one of the plurality of tap boxes is constructed and arranged to split out the three phase from the power cable and provide two of the three phases to the associated step-down transformer.

J. The system of paragraph H or I, wherein the tap boxes are electrically connected to the associated step-down transformer by wet mate connections.

K. The system of any preceding paragraph, wherein the generators have a prime mover selected from the group consisting of gas turbine, steam turbine, diesel powered and wind powered.

L. The system of any preceding paragraph, wherein the generators have a rated output voltage, the generators are constructed and arranged to allow the output voltage to be varied between 50-100% the rated output voltage

M. A method of heating a subsea pipeline composed of pipeline segments, the method comprising: providing a system for providing energy to the pipeline segments comprising: a plurality of variable voltage generators; a plurality of step-up transformers, each step-up transformer electrically connected to the output of an associated generator; and a plurality of variable step-down transformers, each step-down transformer electrically connected the output of the step-up transformers, each step-down transformer is electrically connected to an associated pipeline segment; and delivering energy to at least one pipeline segment.

N. The method of paragraph M, wherein the system for providing energy to the pipeline segments further comprises a plurality of temperature sensors, each temperature sensor associated with one of the pipeline segments, wherein the temperature sensors are constructed and arranged to output a temperature of the associated pipeline segment.

O. The method of any preceding paragraph further comprising: receiving a temperature from at least one temperature sensor; and controlling the operation of at least one of the generator and/or the settings of the step-down transformer based on the received temperature.

P. The method of paragraph O further comprising comparing the received temperature to a predefined temperature range.

Q. The method of any preceding paragraph, wherein the generators have a rated output voltage, the controlling the operation step comprises varying the output voltage of at least one of the generators between 50-100% the rated output voltage.

It should be understood that the preceding is merely a detailed description of specific embodiments of this invention and that numerous changes, modifications, and alternatives to the disclosed embodiments can be made in accordance with the disclosure here without departing from the scope of the invention. The preceding description, therefore, is not meant to limit the scope of the invention. Rather, the scope of the invention is to be determined only by the appended claims and their equivalents. It is also contemplated that structures and features embodied in the present examples can be altered, rearranged, substituted, deleted, duplicated, combined, or added to each other. The articles “the”, “a” and “an” are not necessarily limited to mean only one, but rather are inclusive and open ended so as to include, optionally, multiple such elements.

What is claimed is:

1. A system for heating a subsea pipeline composed of a plurality of pipeline segments comprising:
a plurality of variable voltage generators;
a plurality of step-up transformers, each step-up transformer electrically connected to the output of an associated generator; and
a plurality of variable step-down transformers, each step-down transformer electrically connected the output of the step-up transformers, each step-down transformer is electrically connected to an associated pipeline segment.

2. The system of claim 1 further comprising a plurality of temperature sensors, each temperature sensor associated with one of the pipeline segments, wherein the temperature sensors are constructed and arranged to output a temperature of the associated pipeline segment.

3. The system of claim 2 further comprising a power management system communicatively and operatively connected to the plurality of generators and the plurality of step-down transformers.

4. The system of claim 3, wherein the power management system is communicatively connected the plurality of temperature sensors.

5. The system of claim 1 further comprising a power cable electrically connecting the output of the step-up transformers to the input of the step-down transformers.

6. The system of claim 5 further comprising a fixed reactor electrically connected to the outputs of the step-up transformers in parallel to the power cable.

7. The system of claim 5, wherein the power cable delivers three phase electric power.

8. The system of claim 7 further comprising a plurality of tap boxes electrically connected to the input of an associated step-down transformer, the tap boxes electrically connect the energy delivered by the power cable to the input of the associated step-down transformer.

9. The system of claim 8, wherein at least one of the plurality of tap boxes is constructed and arranged to split out the three phase from the power cable and provide two of the three phases to the associated step-down transformer.

10. The system of claim 8, wherein the tap boxes are electrically connected to the associated step-down transformer by wet mate connections.

11. The system of claim 1, wherein the generators have a prime mover selected from the group consisting of gas turbine, steam turbine, diesel powered and wind powered.

12. The system of claim 1, wherein the generators have a rated output voltage, the generators are constructed and arranged to allow the output voltage to be varied between 50-100% the rated output voltage

13. A method of heating a subsea pipeline composed of pipeline segments, the method comprising:
providing a system for providing energy to the pipeline segments comprising:
a plurality of variable voltage generators;
a plurality of step-up transformers, each step-up transformer electrically connected to the output of an associated generator; and
a plurality of variable step-down transformers, each step-down transformer electrically connected the output of the step-up transformers, each step-down transformer is electrically connected to an associated pipeline segment; and delivering energy to at least one pipeline segment.

14. The method of claim 13, wherein the system for providing energy to the pipeline segments further comprises a plurality of temperature sensors, each temperature sensor associated with one of the pipeline segments, wherein the temperature sensors are constructed and arranged to output a temperature of the associated pipeline segment.

15. The method of claim 14 further comprising:
receiving a temperature from at least one temperature sensor; and
controlling the operation of at least one of the generator and/or the settings of the step-down transformer based on the received temperature.

16. The method of claim 15 further comprising comparing the received temperature to a predefined temperature range.

17. The method of claim 13, wherein the generators have a rated output voltage, the controlling the operation step comprises varying the output voltage of at least one of the generators between 50-100% the rated output voltage.
